(19) United States
(12) Patent Application Publication
(10) Pub. No.: US 2025/0292001 A1
(43) Pub. Date: Sep. 18, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: SATORU TAKAHASHI, Kanagawa (JP)

(21) Appl. No.: 19/069,479

(22) Filed: Mar. 4, 2025

(30) Foreign Application Priority Data
Mar. 12, 2024 (JP) 2024-038106

(51) Int. Cl. G06F 40/134; G06F 40/166; G06K 19/06

(52) U.S. Cl. CPC G06F 40/134; G06F 40/166; G06K 19/06037

(57) ABSTRACT

With the technology of the present disclosure, at the time an original layout is edited to generate another layout, the original layout is easily displayed on a user terminal from that other layout. The document size of another layout data to be created by reusing a base layout data is acquired. Whether or not the document sizes are different between the base layout data and that other layout data, and in a case where the document sizes are different, the base layout data is uploaded to a predetermined server as public data, and link information for accessing the uploaded base layout data is generated. The link information for making it possible to reference the public data stored in the layout DB 410 is acquired. A two-dimensional code is generated based on the acquired link information, and the two-dimensional code is applied to that other layout data.

### BACKGROUND

### Field

The present disclosure relates to a technology for information processing relating to layout editing for objects.

Description of the Related Art

At the time of creating a flyer or poster for advertisement, another layout that is different from one original layout may be created in accordance with multiple document sizes depending on the forms of advertising media. For example, at the time of creating an A4-sized flyer and a pocket-sized tissue flyer, the A4-sized flyer containing a large information amount may be created first, and then the tissue flyer may be created based on the A4-sized flyer. If the tissue flyer is made as a simply reduced version of the A4-sized flyer, objects such as characters and images will be small, resulting in diminishing in visibility.

Japanese Patent Laid-Open No. 2007-133780, reduction limit conditions are set for image data and text data, under which no degradation in image quality or loss of information occurs, and a layout is executed under the set reduction limit conditions, thereby avoiding degradation in visibility of the contents.

However, in the technology described in Japanese Patent Laid-Open No. 2007-133780, in a case where a layout cannot be determined due to a set reduction limit, part of the image data or text data is deleted, which may result in some of the information contained in the original layout being lost. For example, there may be a case in which, since a reduction limit of a map imposes a restriction to ensure a size with good visibility, it is not possible to place all of the objects included in the original layout, and it is necessary to reduce images or text other than the map, or even to delete the map itself.

### SUMMARY

The present disclosure is characterized by an information processing apparatus including: a generating unit configured to generate link information for accessing public data, which is stored in a predetermined server and corresponds to layout data that defines a layout of objects; and an editing unit configured to edit the layout data, wherein the editing unit adds the link information generated by the generating unit to the edited layout data.

Further features of the present disclosure will become apparent from the following description of exemplary embodiments with reference to the attached drawings.

### BRIEF DESCRIPTION OF THE DRAWINGS

FIG. 1 is a diagram illustrating an example of a system configuration related to a layout editing apparatus;

FIG. 2 is a diagram illustrating an example of a hardware configuration of a printing apparatus;

FIG. 3 is a diagram illustrating an example of a hardware configuration of a client terminal and a server device;

FIG. 4 is a diagram illustrating an example of functional blocks of a printing system for the printing apparatus;

FIG. 5 is an example of a layout DB in the first embodiment;

FIG. 6 is a diagram illustrating an example of a layout editing screen on the client terminal in the first embodiment;

FIG. 7 is a diagram illustrating an example of another layout editing screen on the client terminal in the first embodiment;

FIG. 8 is a diagram illustrating an example of a base layout display screen in the first embodiment;

FIG. 9 is a flowchart showing an example of the processing of applying a two-dimensional code to another layout at the time the document size is changed to create the said another layout in the first embodiment;

FIG. 10 is a diagram illustrating an example in which a two-dimensional code is applied to the said another layout editing screen;

FIG. 11 is a diagram illustrating an example of displaying the base layout through a device that has read the two-dimensional code;

FIG. 12 is an example of a printing media information DB;

FIG. 13 is a diagram illustrating an example of the layout editing screen on the client terminal;

FIG. 14 is a flowchart showing an example of the processing of applying a two-dimensional code to the said another layout at the time a particular printing media is selected to create the said another layout in the second embodiment;

FIG. 15 is a flowchart showing an example of the processing of applying an AR marker to the said another layout in the third embodiment; and

FIG. 16 is a diagram illustrating an example of displaying the base layout through a device that has read the AR marker in the third embodiment.

### DESCRIPTION OF THE EMBODIMENTS

Hereinafter, a detailed explanation is given of preferable embodiments of the present disclosure with reference to the accompanying drawings. Noted that the following embodiments are not intended to limit the present disclosure relating to the scope of the patent claims and that every combination of the characteristics explained in the present embodiments is not necessarily essential to the solution provided in the present disclosure.

### First Embodiment

First, an explanation is herein given about an information processing system according to the present embodiment. The information processing system according to the present embodiment is a printing system involving layout editing intended for a printing apparatus. In this printing system, layout editing and print job transmission to a printing apparatus are executed at an externally connected client terminal. At the time of generating a print job, the work of editing the print settings is performed on the screen of the client terminal if necessary.

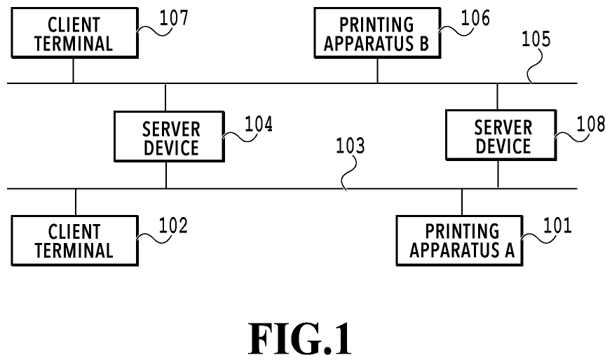

FIG. 1 is a diagram illustrating an example of the system configuration in the network environment of the present system. As shown in FIG. 1, the client terminal 102 is connectable to the server device 104 and the printing apparatus 101 via the network 103. The client terminal 102 performs layout editing work for posters, flyers, etc., and requests the server device 104 to perform some of the layout-related processes such as editing and data processing as well as a rendering process. Furthermore, the client terminal 102 generates a print job by adding print settings to the layout after the editing work, and transmits the print job to the printing apparatus 101. The server device 104 is also connectable to the client terminal 107, the printing apparatus 106, and the server device 108 via the network 105 which different from the above-mentioned network. Although the number of printing apparatuses is one in the present embodiment, there is no such limitation, and the number of printing apparatuses may be one or two or more. Although the number of client terminals and server devices is also one, there may be two or more.

As an example of execution of printing, an explanation is herein given of a system in which a print job is transmitted from a printing application installed on a terminal to the printing apparatus 101 via a printer driver. For example, a printing application and a printer driver are installed on the client terminal 102. The printing application can acquire device information of the associated printing apparatus 101 from the printer driver, as well as printing parameters such as paper type, paper size, and print quality, and edit print settings from among the acquired parameters. A print job is configured based on the above-mentioned print settings and the layout image for which a rendering process has been completed in the server device 104, and the print job is transmitted to the printing apparatus via a spool of the print driver, thereby executing the print processing. The printing apparatus executes printing based on the print settings of the received print job, and holds, as print history information, information that can identify the transmission source of the print job, such as the print user or the client terminal 102, as well as a group of print-related parameters used during printing. In a case where printing cannot be executed normally due to a problem with the printing apparatus, such as a shortage of the paper or an empty ink, or an error in the print settings, a warning message is displayed on the main body panel to inform the user of the reason why printing cannot be performed normally.

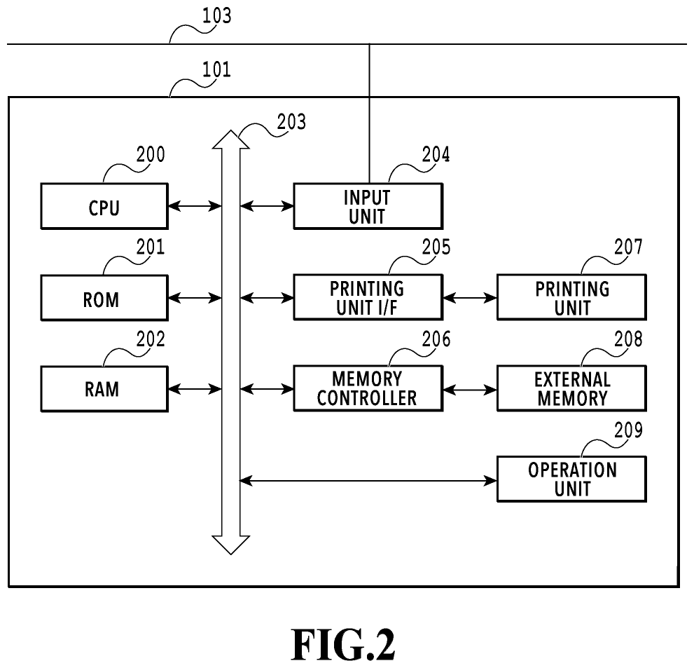

FIG. 2 is a diagram illustrating an example of the hardware configuration of the printing apparatus 101. Note that the printing apparatus 106 has a similar configuration, and thus an explanation thereof is omitted. The printing apparatus 101 is controlled by the CPU 200. The CPU 200 operates based on a control program or the like stored in a program ROM of the ROM 201 or a control program or the like stored in the external memory 208. The CPU 200 outputs an image signal as output information to the printing unit (the printer engine) 207 connected to the printing unit I/F 205 via the system bus 203. The CPU 200 is capable of performing communication processing with the client terminal 102 via the input unit 204, and can notify the client terminal 102 of the information inside the printing apparatus 101. Further, the CPU 200 can receive output data to be output to the printing unit 207 via the input unit 204. The RAM 202 functions as a main memory, a work area, etc., of the CPU 200, and is configured so that the memory capacity can be expanded by an optional RAM connected to an expansion port which is not illustrated in the drawings. Note that the RAM 202 is used as an output information loading area, an environment data storage area, a non-volatile memory, and the like. Access to the external memory 208, which may be a hard disk drive (HDD), an IC card, or the like, is controlled by the memory controller 206. The external memory 208 can be connected as an option, and, as print history information, the external memory 208 stores font data, emulation programs, form data, information relating to the type and size of fed paper, and print-related parameters used during execution of printing. Further, the operation unit 209 includes a panel that can display various types of information.

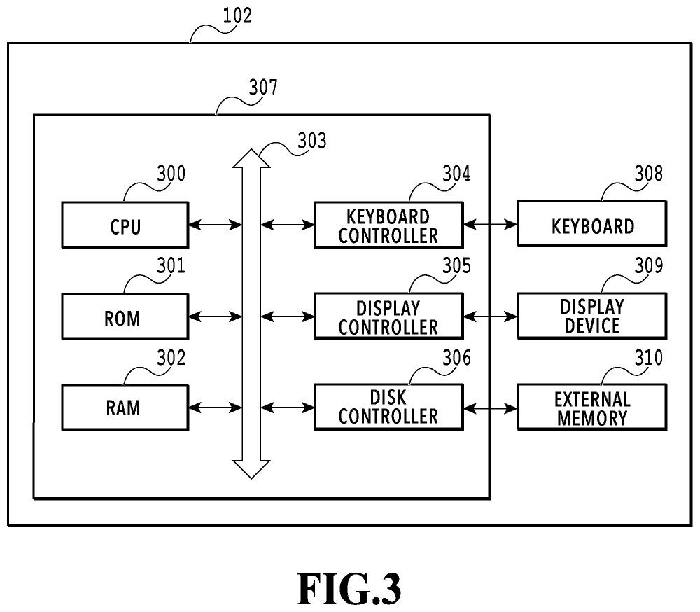

FIG. 3 is an example of a block diagram illustrating the hardware configuration of an information processing apparatus that can be used as the client terminals 102 and 107 and the server device 104 shown in FIG. 1. The terminal and the device interior 307 include the CPU 300, the ROM 301, the RAM 302, the keyboard controller 304, the display controller 305, and the disk controller 306. The CPU 300 reads out various programs, such as a control program, a system program, and an application program, from the external memory 310 via the disk controller 306 into the RAM 302. The CPU 300 executes the various programs read out into the RAM 302 to perform various data processing and performs display control of the display device 309. The CPU 300 may read out a control program or the like from the ROM 301. It is also possible that the CPU 300 is a dedicated circuit such as an ASIC. The CPU 300 and a dedicated circuit are examples of a hardware circuit or hardware processor. The disk controller 306 controls access to the external memory 310, which may be an HD, a CD-ROM, a DVD-ROM, a USB, or the like. The RAM 302 is configured so that the capacity thereof can be expanded by an optional RAM or the like which is not illustrated in the drawings, and is mainly utilized as a work area for the CPU 300. The keyboard controller 304 controls key input from the keyboard 308 or a pointing device which is not illustrated in the drawings. The display controller 305 controls display of the display device 309. Note that, in the embodiments of the present disclosure, unless otherwise specified, the CPU 300 controls each unit connected to the main bus 303 via the main bus 303. Additionally, needless to say, in the server device 104, components that are not necessarily essential, such as the display device 309, do not have to be included in the configuration.

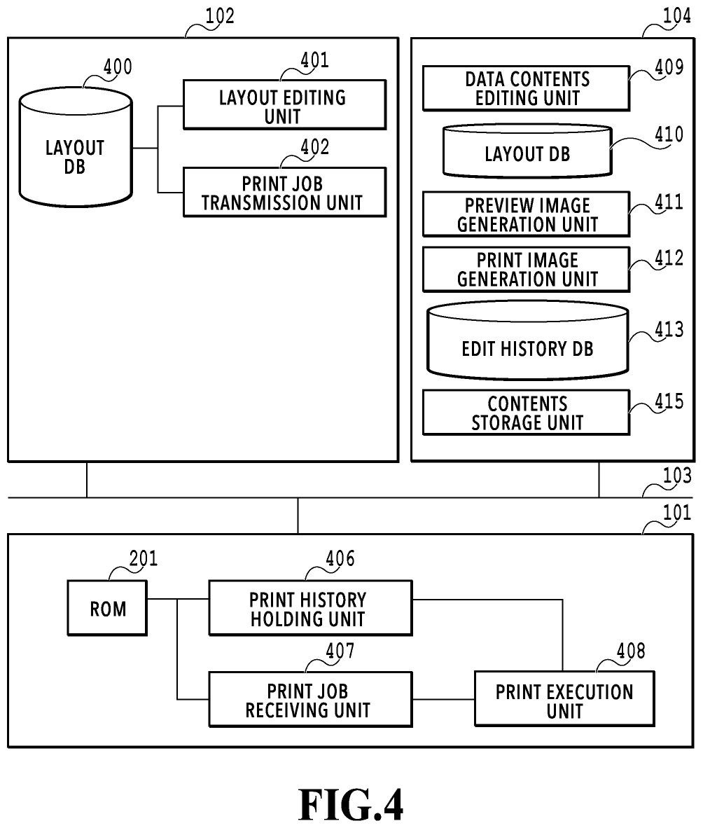

FIG. 4 is a diagram illustrating an example of the functional blocks of the present system relating to the printing apparatuses 101 and 106, the client terminals 102 and 107, and the server device 104 explained with reference to FIG. 1 to FIG. 3. First, an explanation is herein given about the functional blocks within the client terminal 102 and the server device 104.

The layout editing unit 401 adds and deletes contents such as text objects and image objects to be laid out, and adjusts the layout of each object based on user's input or the like. In a case of executing contents processing such as cutting or filling, the layout editing unit 401 requests the data contents editing unit 409 of the server device 104 to perform that processing. The layout editing unit 401 generates layout data after editing in the layout editing unit 401, and stores the generated layout data in the layout DB 400 of the client terminal 102 or the layout DB 410 of the server device 104. In a case where layout data is stored in the layout DB 410, the layout data is stored in a predetermined storage location provided for each client terminal 102 (or for each account if a user account exists).

The contents edited in the layout DB 400 are transmitted from the client terminal 102 to the server device 104 and stored in the edit history DB 413. The contents edited in the layout DB 410 are stored in the edit history DB 413 by the server device 104.

The content storage unit 415 stores contents such as image objects handled by a layout editing application. The content storage unit 415 may be configured with a database for managing the contents.

The print job transmission unit 402 generates a print job based on a print image generated by the print image generation unit 412, and transmits the generated print job to the printing apparatus 101. At the time of generating a print job, the print job transmission unit 402 requests the preview image generation unit 411 or the print image generation unit 412 of the server device 104 to perform a process of generating a preview image of a layout or a print image, and acquires the preview image or the print image.

Next, an explanation is herein given about the functional blocks within the printing apparatus 101. The ROM 201 includes the print history holding unit 406, the print job receiving unit 407, and the print execution unit 408. The print job receiving unit 407 receives a print job transmitted from the client terminal 102. The print execution unit 408 executes print processing based on the received print job. A group of print-related parameters used during this print processing is held in the print history holding unit 406 as print history information.

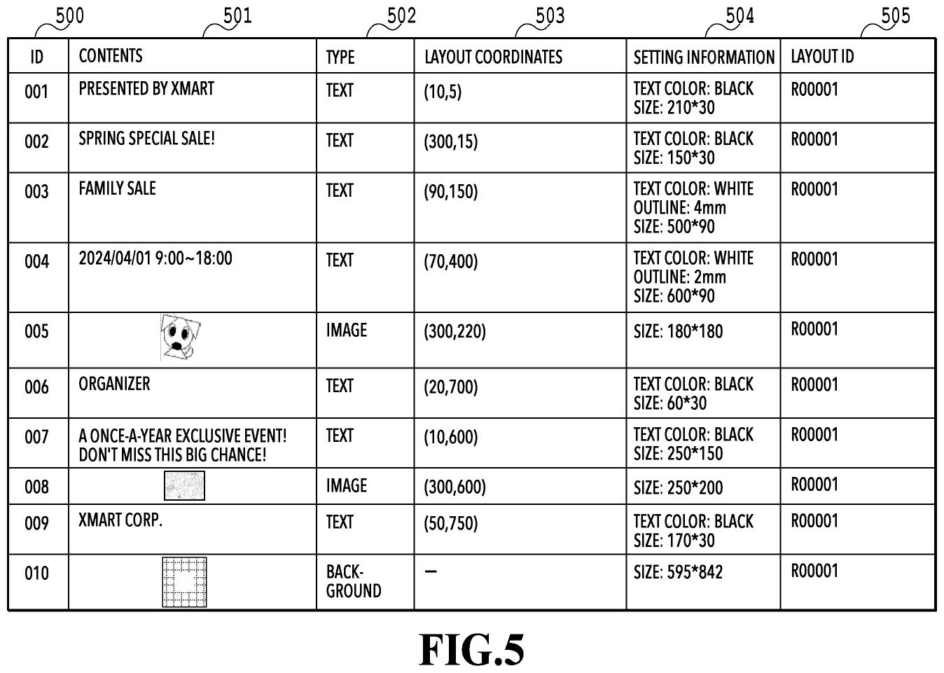

FIG. 5 is a diagram illustrating an example of layout data stored in the layout DB 400 and the layout DB 410, and such layout data as illustrated in FIG. 5 is generated for each layout. The layout data includes parameters such as the ID 500 for uniquely identifying an object, the contents 501 to be the main body of object data, the object type 502, the layout coordinates 503, the setting information 504, and the layout ID 505.

In the contents 501, the main body of the data of each object such as a laid out character object and image object is set. In the object type 502, information indicating the type of object (“TEXT” for a text object, and “IMAGE” for an image object) is set. In the layout coordinates 503, values indicating the position of the object on a layout is set. In the setting information 504, attribute values indicating a size, color, etc., for each object are set. In the layout ID 505, an ID for identifying the layout data including the object is set.

The settings relating to an entire layout, such as a document size and data for variable printing, are also held as layout data. Further, the contents entities can be held in the contents 501, the setting types can be held in the object type 502, and the setting values can be held in the setting information 504. Needless to say, these pieces of information may be held in a file separate from the layout data, and information other than the above may be included in the layout data.

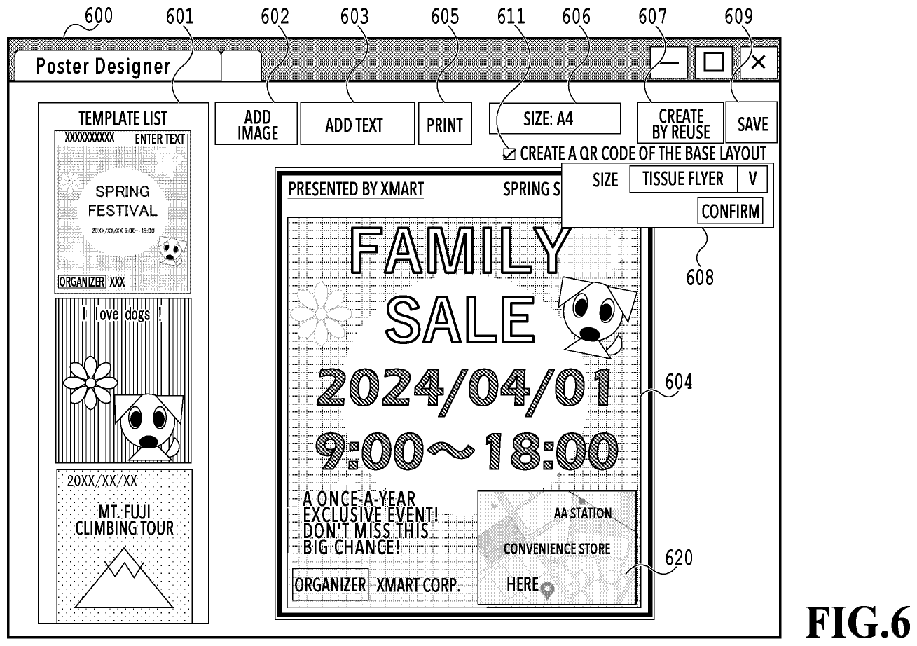

FIG. 6 shows an example of the Web browser-based layout editing screen 600 displayed on the display device 309 of the client terminal 102 in the first embodiment. On the layout editing screen 600, a template that is closest to the completed layout can be viewed and selected in the template list 601. The selected template is displayed in the layout editing area 604. The template information displayed in the template list 601 may be acquired from the layout DB 400 or the preview image generation unit 411, or may be acquired from an external cloud service or an SNS service.

For each of the laid-out objects displayed in the layout editing area 604, the layout editing unit 401 executes editing of the contents, such as position adjustment, cutting, or filling. Further, in a case where the user presses the add image button 602 to add an image to the layout editing area 604, for example, a file dialog is called up, so that an import process is performed based on a designated path to the image file to be added. In a case where the add text button 603 is pressed, a text object with no text input is added to the layout editing area 604. The initial state of an added text object is not limited to blank text, but may be in a state where a phrase that prompts text input, such as a placeholder, is input in advance. Note that additional buttons corresponding to other content types may be arranged, and, as an import source at the time of adding an image, an external cloud service storage or SNS service may be provided as a choice of designation, for example.

If the print execution button 605 is pressed to print the displayed layout, a request is made to the print job transmission unit 402 to generate a print job for the layout displayed in the layout editing area 604 and to transmit the print job to the printing apparatus 101. In the size display frame 606, the current document size of the layout is displayed. The document size may be changed by pressing the size display frame 606. At this time, the method for changing the document size may be selecting a document size prepared in advance as a pull-down menu, or inputting width and height values.

If the create-by-reuse button 607 is pressed, it is possible to create another layout based on the displayed layout. If the pressing of the create-by-reuse button 607 is accepted, the confirmation dialog 608 is displayed. If the output size is designated by text input or a pull-down menu and the confirm button is pressed, the preview image generation unit 411 creates an image of the layout based on the latest edited contents, which are held in the layout DB 400 or the layout DB 410. If the preview image generation unit 411 uploads the imaged layout to the server device 104, a URL of the upload location is issued. At this time, if there is no difference between the size of the base layout and the selected size, uploading the layout to the server device 104 may be omitted. Further, by accessing the issued URL with a Web browser, it is possible to check the image rendered based on the layout data.

If the save button 609 is pressed, the layout edited in the layout editing area 604 is saved in the layout DB 400 or the layout DB 410. Note that the layout may be saved periodically, such as every time an editing operation is received. Note that, at the time the create-by-reuse button 607 is pressed, it is preferable that the base layout is automatically saved before the processing of creating another layout.

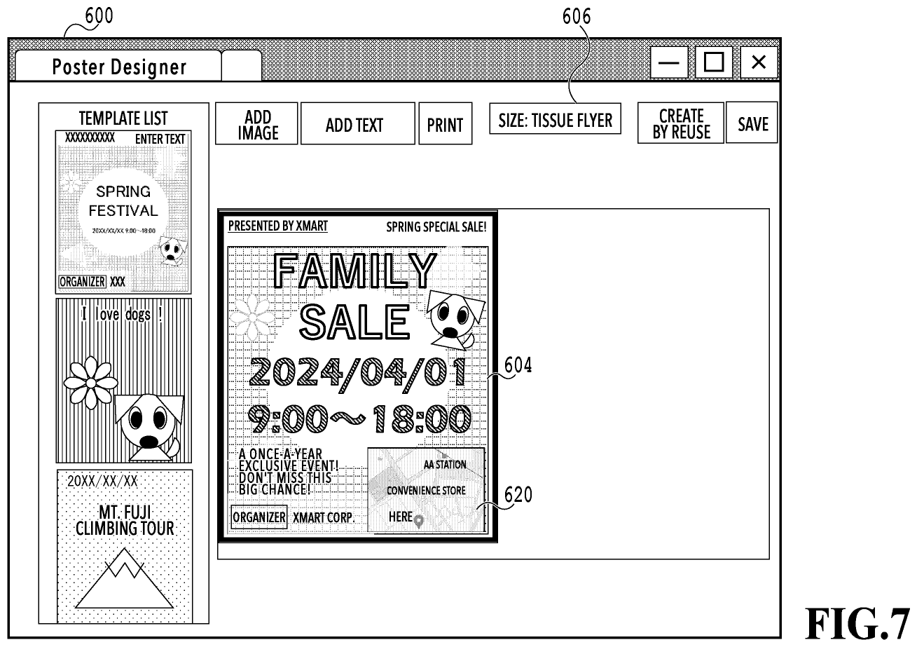

FIG. 7 shows an example of the Web browser-based layout editing screen 600 displayed on the display device 309 of the client terminal 102 in the present embodiment, which is an example of displaying the layout data newly created by pressing the create-by-reuse button 607. In the size display frame 606, the document size confirmed in the confirmation dialog 608 is displayed. The layout data displayed in the layout editing area 604 is the layout data created by resizing the layout data displayed in the layout editing area 604 of FIG. 6 to the size displayed in the size display frame 606. Note that the resizing method in the example shown in FIG. 7 is a method of enlarging or reducing the image by aligning it to the upper left so that the image fits within the size displayed in the size display frame 606, but is not limited to this method. For example, in a case where the layout data in the A4 document size is reused and resized to a smaller document size such as a size of a pocket tissue, the visibility of the map 620 may become poor, and there is a possibility that the map is deleted.

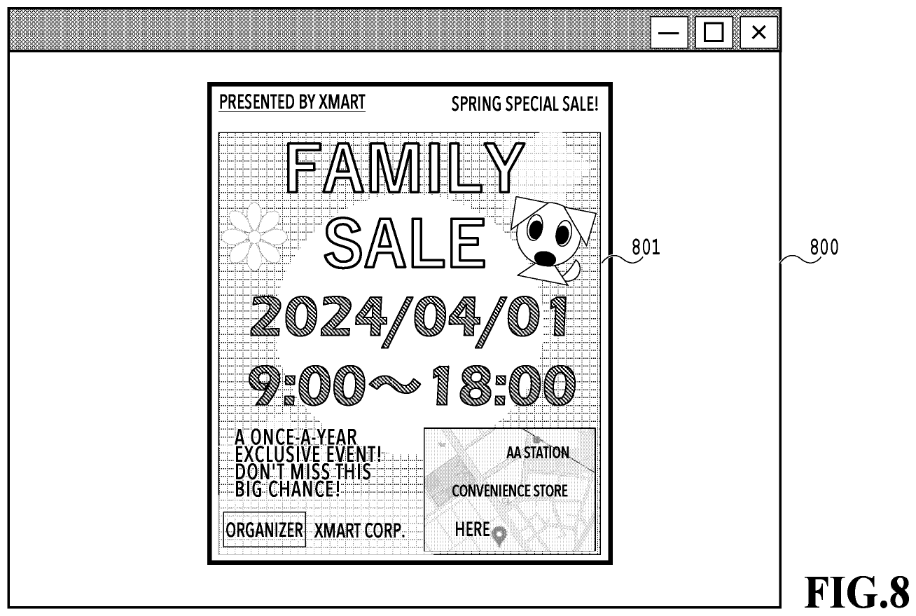

FIG. 8 is a diagram illustrating an example of a Web browser-based base layout display screen in the present embodiment. The shared image 801, which is an image rendered by the preview image generation unit 411 of the server device 104 based on the layout data displayed in the layout editing area 604, is embedded in the base layout display screen 800. The base layout display screen 800 is displayed if a storage location of the layout data stored by the content storage unit 415 is accessed using a Web browser based on the link information indicating the storage location. For example, by reading a two-dimensional code such as a QR code (registered trademark) with a user terminal to access the URL of the link information acquired from the two-dimensional code using a Web browser, the base layout display screen 800 can be displayed on the display device of the user terminal.

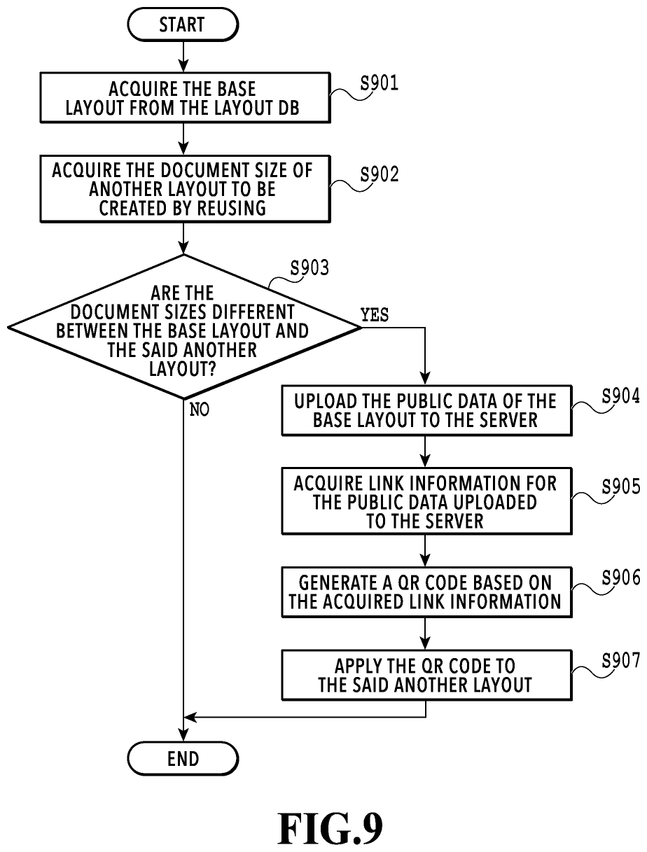

FIG. 9 shows a flowchart for explaining an example of the processing of applying a two-dimensional code for accessing the public data of the base layout data to another layout data generated by editing the base layout data. The processing shown in FIG. 9 is executed at the time the create-by-reuse button 607 on the layout editing screen 600 is pressed and the confirmation of a document size is accepted via the confirmation dialog 608.

In S901, the CPU 300 acquires the base layout data currently being edited from the layout DB 400 or the layout DB 410. Note that, in the following explanation, it is assumed that the base layout data is acquired from the layout DB 400.

In S902, the CPU 300 acquires the document size of another layout data to be created by reusing the base layout data.

In S903, the CPU 300 determines whether or not the document sizes are different between the base layout data and the said another layout data. Further, in a case where the document sizes are different, the processing proceeds to S904, and in a case where the document sizes are the same, the present flow ends. Note that an explanation is herein given about a case in which the document size of the said another layout data is smaller than that of the base layout data and the information amount in the said another layout data is reduced compared to that of the base layout data. That is, in a case where the document size of the said another layout data is smaller than that of the base layout data, the CPU 300 proceeds the processing to S904, and in a case where the document size of the said another layout data is equal to or larger than that of the base layout data, the CPU 300 ends the present flow. Here, a reduction in the information amount indicates that the visibility of objects is diminished and the amount of information that a person can read from the displayed layout is reduced.

In S904, the CPU 300 uploads the base layout data, which is the layout data before editing of the said another layout data, to a predetermined server that can store the base layout data as public data. At this time, instead of uploading the base layout data, image data obtained by rendering the base layout data may be uploaded as the public data. As a method for rendering the layout data, for example, in a case where the layout editing application is a Web application and the layout data is configured in HTML, the image data may be generated using a screenshot function of the Web browser. The <font>tag is used for the font of a text object, the <svg>tag is used for a graphics object, and the <img>tag is used for an image object. Using a library that controls the Web browser, this HTML data can be browsed in a HEADLESS mode, so that raster image data can be generated by designating an image resolution, etc., and executing the screenshot function. An example of the library is Puppeteer (https://pptr.dev/). In this way, in a case where the layout editing application is a Web application and the layout data is configured in HTML, the display result may vary depending on the renderer. For this reason, it is preferable that the data to be uploaded is image data obtained by rendering the base layout data in advance. This image data generated by rendering the base layout data is stored in the content storage unit 415. Note that the predetermined upload location server may be any server that is publicly available and has a storage area that can be accessed based on the link information, and may be the layout DB 410 of the server device 104. Further, in a case where the storage location on the predetermined server and the layout DBs 400 and 410 are synchronized in advance and the layout data is stored on the predetermined server, the uploading in S904 may be omitted and only the generation of the link information may be performed.

In S905, the CPU 300 acquires link information for making it possible to reference the public data. FIG. 8 shows the base layout display screen 800 that is displayed if the address indicated by the generated link information is accessed by a Web browser. In this way, the base layout can be checked by accessing the data upload location based on the link information. Note that, in a case where the uploaded data is base layout data, not image data, it is necessary to render the base layout data using an application capable of rendering.

In S906, the CPU 300 generates a two-dimensional code such as a QR code based on the acquired link information. A two-dimensional code is to be generated in the present embodiment, but instead of the two-dimensional code, it is also possible that the URL character string contained in the link information is added directly to the layout data, and in that case, S906 may be omitted.

In S907, the CPU 300 applies the two-dimensional code to the said another layout data. For example, the layout position of the two-dimensional code is arranged with reference to the layout DB, so as to be a position where the two-dimensional code does not overlap with other objects included in the layout data. In a case where it is not possible to place the two-dimensional code at a position not overlapping with other objects, the two-dimensional code is placed at the center of the document. Note that, even if link information has been generated, whether or not to apply a two-dimensional code may be determined based on information designating whether or not a two-dimensional code is applicable, so that whether or not to add a two-dimensional code is switched. For example, a check box may be provided on the layout editing screen 600 to switch whether or not the two-dimensional code is applicable, so that, in a case where the check box is checked, the two-dimensional code is applied, and in a case where the check box is not checked, the two-dimensional code is not applied. In the case where the check box is not checked, the base layout data or image data may not be uploaded to the server in S904. Note that in the case where a URL character string is generated in S906, the URL character string, not a two-dimensional code, is applied to the said another layout data.

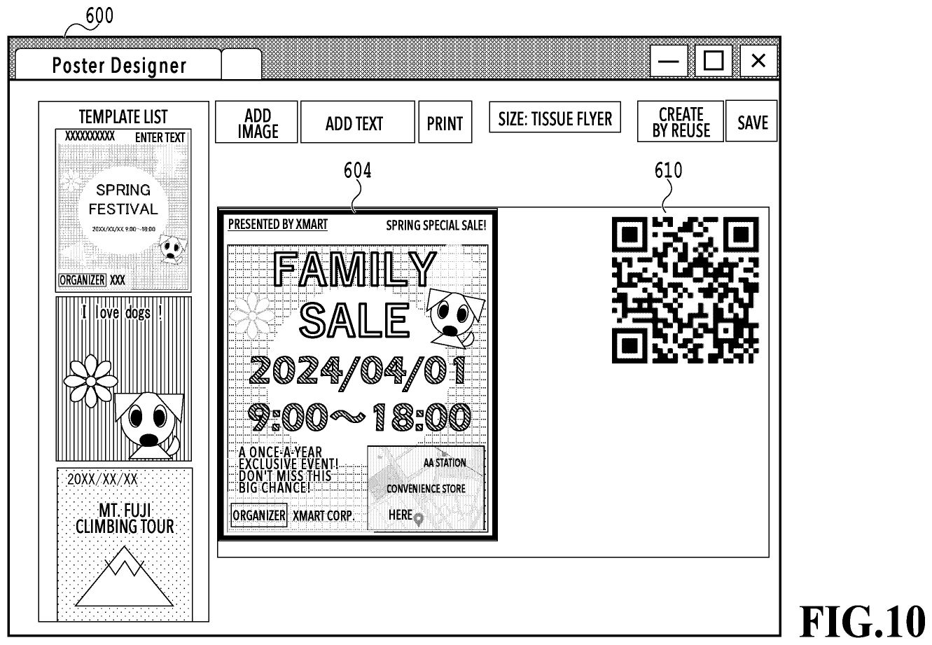

FIG. 10 shows a state after the two-dimensional code 610 is placed in the layout editing area 604 of the layout editing screen 600 illustrated in FIG. 7. The two-dimensional code 610 to be placed has a size that can be read even if the document size is the size of a tissue flyer. Note that the size of a tissue flyer is about 1100 pixels wide and 1650 pixels high at 350 dpi.

Note that the two-dimensional code may be added to the existing layout at the time an object on the layout editing area 604 is selected and the selected object is deleted from the layout editing area 604 and the layout DB 400. As a method for deleting an object, for example, deleting is executed at the time an object on the layout editing area 604 is selected based on a user's input and the user presses a “Delete” key.

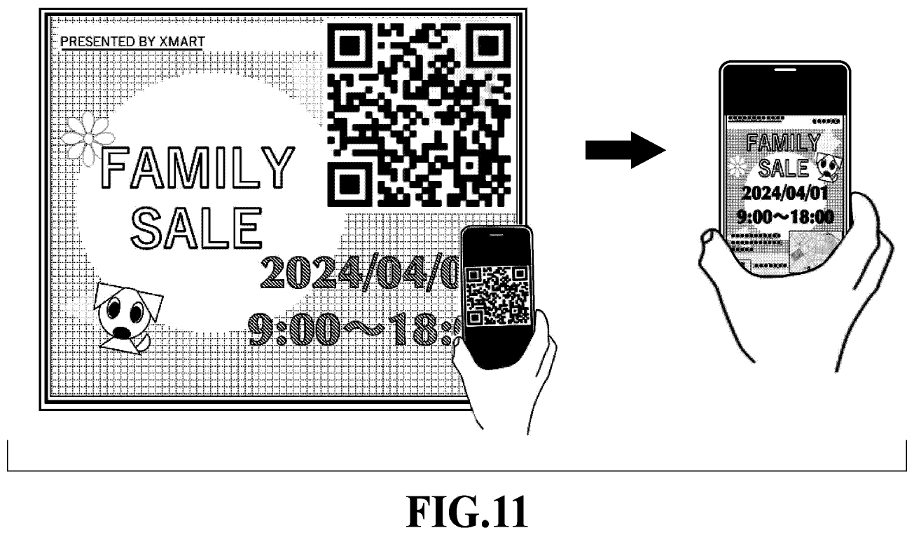

FIG. 11 shows a tissue flyer created by editing the layout displayed in the layout editing area 604 illustrated in FIG. 10, and shows the result of reading the two-dimensional code on the tissue flyer with a user terminal. Note that, in the layout of the tissue flyer illustrated in FIG. 11, the image of the map is deleted from the base layout illustrated in FIG. 6. As illustrated in FIG. 11, if the two-dimensional code is read by a user terminal, the base layout is displayed on the user terminal. Thereby, it is possible to check the map that are present in the base layout but not in the said another layout of the tissue flyer. Note that, instead of the two-dimensional code, it is also possible to display the base layout on the user terminal by reading a URL character string applied to the layout with an OCR application.

As described above, in a case where another layout data is created by reusing base layout data, link information for displaying the base layout on a user terminal can be easily added to the said another layout data.

### Second Embodiment

In the first embodiment, in a case where another layout is created by reusing a base layout, if the document size is changed, a two-dimensional code for referencing the base layout is applied to the said another layout that is created by reusing the base layout. However, in the second embodiment, a two-dimensional code is applied to reference a base layout at the time a particular printing medium is selected. This is because even if the document size does not change, information may be lost if the said another layout is required to meet conditions set for a particular printing medium.

The herein-mentioned printing medium refers to a medium on which printing is performed, such as a business card, and the type of the printing medium, such as Japanese paper or glossy paper. Since business cards often do not include contents such as images, in a case where a business card is designated as a printing medium, it is conceivable to impose a condition that prohibits the use of image contents. Further, since coloring materials tend to bleed on Japanese paper, causing printed characters to become blurred, in a case of using Japanese paper as a printing medium, it is conceivable to set a lower limit on the font size so that character strings are legible. Therefore, in a case where Japanese paper is designated as the printing medium, it may be required to increase the font size of some of the text, which may result in not all of the text fitting and some of the information included in the base layout being lost. In addition, a technology now exists for printing on a mug or the like, and media other than paper may be designated as the printing medium. Therefore, in the second embodiment, the two-dimensional code for referencing the base layout is applied to the said another layout that is generated at the time a preset particular printing medium is selected.

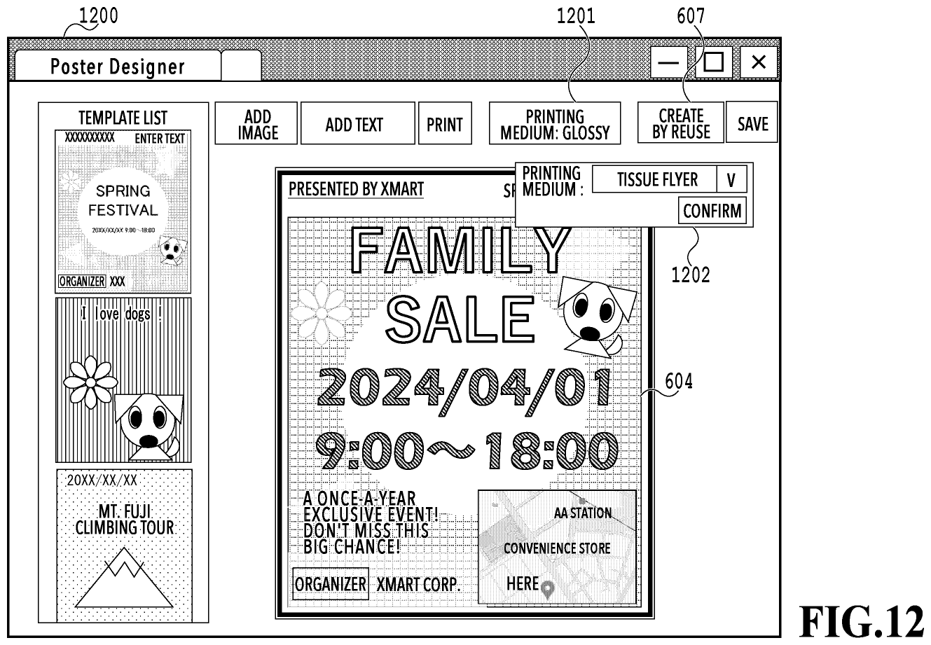

FIG. 12 shows an example of the Web browser-based layout editing screen 1200 displayed on the display device 309 of the client terminal 102 in the second embodiment. In this layout editing screen 1200, the printing medium display frame 1201 is provided instead of the size display frame 606 of the layout editing screen 600 illustrated in FIG. 6. If the create-by-reuse button 607 is pressed on the layout editing screen 1200, the confirmation dialog 1202 is displayed in which a printing medium can be selected instead of a size.

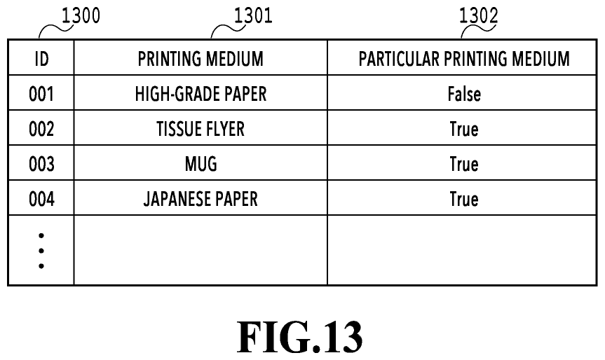

FIG. 13 shows an example of a printing medium information DB registered in the content storage unit 415. The parameters such as the ID 1300 for uniquely identifying each printing medium, the printing medium 1301, and the particular printing medium 1302 are included. In the printing medium 1301, each printing medium's name to be displayed in the layout editing application is set. A flag indicating whether or not a two-dimensional code is to be applied is set in the particular printing medium 1302. A two-dimensional code is applied in a case where “True” is set in the particular printing medium 1302, and the two-dimensional code is not applied in a case where “False” is set in the particular printing medium 1302.

Note that the setting values of the particular printing medium 1302 in the printing medium information DB illustrated in FIG. 13 are setting values for the case where the print surface of the printing medium on which the base layout is to be printed is glossy. Regarding the setting values of the particular printing medium 1302, if the printing medium of the base layout data is different, the values of the particular printing media 1302 for the respective printing media may be different. Further, the printing medium information DB may be divided for each type of printing medium and operated as separate files, and printing medium types other than those mentioned above may be included in the layout data.

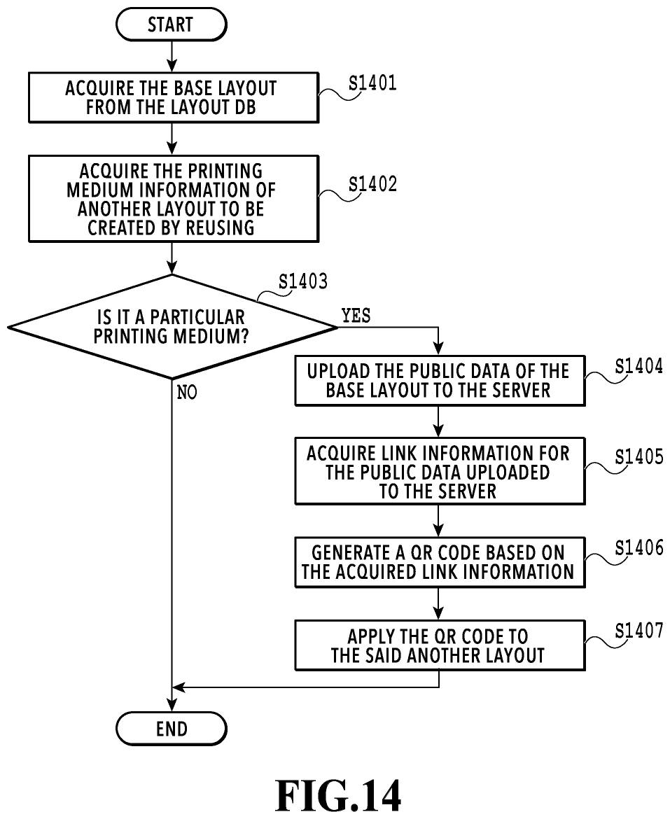

FIG. 14 shows a flowchart explaining the processing of applying a two-dimensional code to the said another layout data created by reusing at the time the create-by-reuse button 607 on the layout editing screen 1200 in the second embodiment is pressed and a confirmation for the printing medium is accepted via the confirmation dialog 1202. In the present embodiment, at the time the create-by-reuse button 607 on the layout editing screen 1200 is pressed, the printing medium 1301 from the printing medium information DB illustrated in FIG. 13 is displayed as the options displayed in the confirmation dialog 1202, so that the user is allowed to select a printing medium.

Since S1401 is similar to S901 of the first embodiment, an explanation thereof is omitted here. Note that the base layout data acquired in S1401 includes printing medium information.

In S1402, the CPU 200 acquires the printing medium information of another layout data to be created by reusing the base layout data.

In S1403, in a case where the particular printing medium 1302 in the printing medium information acquired in S1402 is “Ture”, the CPU 300 executes $1404 to S1407, and in a case of “False”, the CPU 300 ends this series of flow.

Since S1404 to S1407 are similar to S904 to S907 of the first embodiment, explanations thereof are omitted here.

As described above, in a case where another layout data for a different printing medium is created by reusing base layout data, link information for displaying the base layout on a user terminal can be easily added to the said another layout data.

### Third Embodiment

In the first and second embodiments, in a case where another layout is created by reusing a base layout, if the document size or the printing medium is changed, a two-dimensional code, a URL character string, or the like for referencing the base layout is applied to the said another layout that is created by reusing the base layout. However, in the present embodiment, an AR marker, not a two-dimensional code or a URL character string, is applied to the said another layout data. In this case, if the user terminal reads the AR marker using a predetermined AR application, an image of the base layout can be displayed on the user terminal.

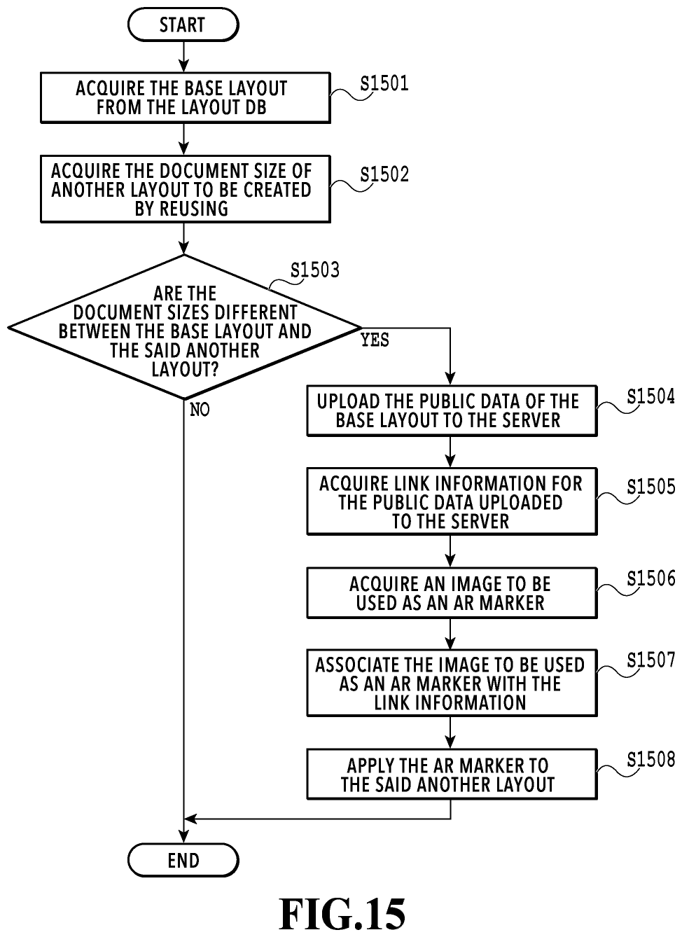

FIG. 15 shows a flowchart for explaining the processing of applying the AR marker to the said another layout created by reusing at the time the create-by-reuse button 607 on the layout editing screen 600 in the third embodiment is pressed and a confirmation for a size is accepted via the confirmation dialog 608.

Since S1501 to S1505 are similar to S901 to S905 of the first embodiment, explanations thereof are omitted here.

In S1506, the CPU 300 acquires image data to be used as the AR marker from the content storage unit 415 of the server device 104 or the server device 108.

In S1507, the CPU 300 associates link information of the base layout data with the image data to be used as the AR marker. This is for allowing an AR application to acquire the link information associated with the AR marker by accessing the server since an AR marker cannot retain link information, whereas a two-dimensional code can retain link information.

Note that, in a case of using an external server in a cooperative manner, for example, link information may be transmitted from the printing apparatus 101 to the server device 108, which is the external server, and the image data to be used as an AR marker associated with the link information may be acquired from the server device 108. In such a configuration, S1506 and S1507 may be modified as appropriate.

In S1508, the CPU 300 applies the AR marker to the said another layout data in the same manner as in S907 of the first embodiment, where the two-dimensional code is applied to the said another layout data.

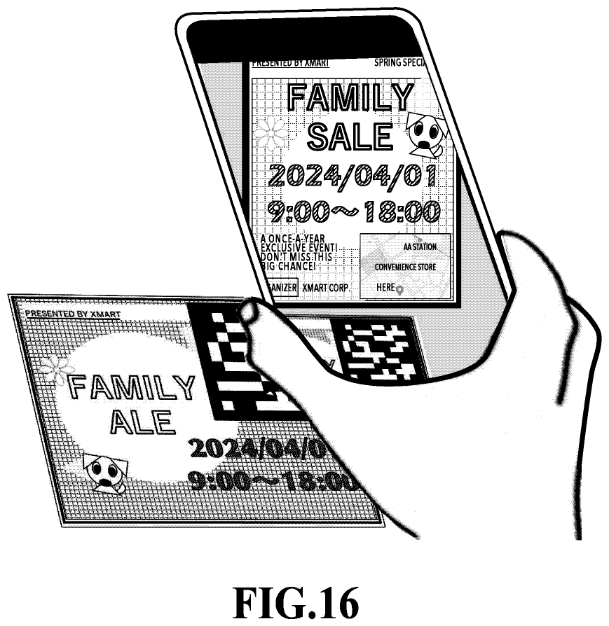

FIG. 16 is a diagram illustrating the result of reading, with a user terminal, an AR marker on a tissue flyer, which is printed with a layout edited on the layout editing screen 600 to which the AR marker is added. If the AR marker is read by an AR application on the user terminal, an image obtained by rendering the base layout data can be superimposed and displayed on the image captured by the user terminal in real time.

As described above, an AR marker for referencing base layout data can be easily applied to another layout which is created by reusing the base layout data. This makes it possible that, even with another layout data which is different from base layout data, the base layout can be easily presented using a user terminal.

In the above-described first to third embodiments, the processing of adding link information for accessing public data, which corresponds to layout data before editing, to edited layout data is executed in a case where the document size or printing medium is changed. On the other hand, even if there is no change in the information amounts between the base layout and another layout, the external impression may be significantly changed between the base layout and another layout. In such cases, it may be desirable to show the base layout from the said another layout. Therefore, in the present disclosure, even if there is no change in the document size or printing medium, in a case where the said another layout is different from the base layout, the processing of adding link information for accessing the public data, which corresponds to the base layout data, to the said another layout data may be executed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) ™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the present disclosure, at the time an original layout is edited to generate another layout, the original layout can be easily displayed on a user terminal from the said another layout.

This application claims the benefit of Japanese Patent Application No. 2024-038106 filed Mar. 12, 2024, which is hereby incorporated by reference wherein in its entirety.

1. An information processing apparatus comprising:
a generating unit configured to generate link information for accessing public data, which is stored in a predetermined server and corresponds to layout data that defines a layout of objects; and
an editing unit configured to edit the layout data,
wherein the editing unit adds the link information generated by the generating unit to the edited layout data.

2. The information processing apparatus according to claim 1 further comprising,
an upload unit configured to upload the public data to the predetermined server.

3. The information processing apparatus according to claim 1,
wherein the public data is layout data before the editing of the edited layout data.

4. The information processing apparatus according to claim 1,
wherein the public data is image data obtained by rendering the layout data before the editing of the edited layout data.

5. The information processing apparatus according to claim 1,
wherein the generating unit generates the link information as a two-dimensional code.

6. The information processing apparatus according to claim 1,
wherein the generating unit generates the link information as a URL character string.

7. The information processing apparatus according to claim 1,
wherein the generating unit generates the link information as an AR marker associated with the link information.

8. The information processing apparatus according to claim 1,
wherein the editing unit places an object representing the link information so as not to overlap with another object included in the edited layout data.

9. The information processing apparatus according to claim 1,
wherein the generating unit generates the link information in a case where the document size of the edited layout data is smaller than the document size of the layout data before the editing of the edited layout data.

10. The information processing apparatus according to claim 1,
wherein the generating unit generates the link information in a case where a printing quality decreases because printing media are different between the edited layout data and the layout data before the editing of the edited layout data.

11. The information processing apparatus according to claim 1,
wherein the generating unit generates the link information in a case where the edited layout data does not include all the objects included in the layout data before the editing of the edited layout data.

12. The information processing apparatus according to claim 1,
wherein user input is received, so that, depending on the user input, the generating unit determines whether or not to generate the link information.

13. The information processing apparatus according to claim 1,
wherein user input is received, so that, based on the user input, the editing unit edits the layout data before the editing of the edited layout data.

14. The information processing apparatus according to claim 1,
wherein the layout data includes the data of the objects laid out as well as the coordinates and sizes of the objects laid out.

15. The information processing apparatus according to claim 1,
wherein the link information is a URL of a storage location of the public data.

16. An information processing method comprising:
a step for generating link information for accessing public data, which is stored in a predetermined server and corresponds to layout data that defines a layout of objects; and
a step for editing the layout data,
wherein, in the editing step, the link information generated in the generating step is added to the edited layout data.

17. A non-transitory computer readable storage medium storing a program that causes a computer to execute an information processing method, the information processing method comprising:
a step for generating link information for accessing public data, which is stored in a predetermined server and corresponds to layout data that defines a layout of objects; and
a step for editing the layout data,
wherein, in the editing step, the link information generated in the generating step is added to the edited layout data.
